(19) United States
(12) Patent Application Publication
(10) Pub. No.: US 2026/0154534 A1
(43) Pub. Date: Jun. 4, 2026

(54) AUTOMATED TESTING OF GENERATIVE ARTIFICIAL INTELLIGENCE MODELS

(71) Applicant: Google LLC, Mountain View, CA (US)

(72) Inventor: Johnathan Samuel Simon, Mountain View, CA (US)

(73) Assignee: Google LLC, Mountain View, CA (US)

(21) Appl. No.: 18/964,031

(22) Filed: Nov. 29, 2024

(51) Int. Cl. G06N 3/0475; G06F 9/451; G06F 11/36

(52) U.S. Cl. CPC G06N 3/0475; G06F 9/451; G06F 11/3698

(57) ABSTRACT

Implementations described herein relate to methods, devices, and computer-readable media to test a generative model. In some implementations, a method includes generating a plurality of prompts, wherein each prompt is associated with a respective test category. The method further includes, for each of the plurality of prompts, providing the prompt to a generative model and capturing a response to the prompt produced by the generative model. The method further includes storing the prompt and the response in a database. The method further includes analyzing respective pairs of prompts and corresponding responses in the database to determine generative model performance. Analyzing the respective pairs include determining, using a safety filter, a test result for each pair that indicates whether the response violates a policy associated with the test category.

### BACKGROUND

Generative artificial intelligence (gen-AI) models are used in a variety of applications and use contexts. Some examples of gen-AI models include large language models (LLMs), including multimodal LLMs, diffusion models that generate images and/or video, and audio generation models. Gen-AI models are used in applications such as chatbots that interact with human users, where a gen-AI model provides responses to user prompts; image creation/editing applications, where a gen-AI model generates or modifies images; document editing/viewing applications, where a gen-AI model provides text such as document summaries, answers to user questions about the document, etc.; and so on.

In certain cases, a gen-AI model may generate responses that are incorrect, inappropriate, harmful, or non-responsive to user prompts. It is helpful to test the gen-AI model for such issues prior to deployment in a user-facing application. However, since gen-AI models are capable of generating responses across different knowledge domains and in different modalities, manual testing of such models can fail to cover the range of possible prompts that lead the model to generate such responses. Manual testing of gen-AI models is expensive, time-consuming, and inadequate.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, devices, and computer-readable media to test a generative model. In some implementations, a computer-implemented method includes generating, using a prompt generator, a plurality of prompts, each prompt associated with a respective test category. Each prompt may include one or more of prompt text, prompt image, prompt audio, or prompt video. The method further includes, for each of the plurality of prompts, providing the prompt to the generative model and capturing a response to the prompt produced by the generative model. The response may include one or more of: response text, response image, response audio, or response video. The method further includes, for each of the plurality of prompts, storing the prompt and the response in a database. The method further includes analyzing respective pairs of prompts and corresponding responses to determine generative model performance., wherein the analyzing comprises, for each pair of prompts, determining, using a safety filter, a test result that indicates whether the response violates a policy associated with the test category.

In some implementations, generating the plurality of prompts includes sending a command to the prompt generator, wherein the command includes one or more sample prompts for the test category. In these implementations, the method further includes receiving, in response to the command, one or more prompts of the plurality of prompts. In some implementations, the test category includes one or more of prohibited, safety-based, or privacy-based.

In some implementations, the generative model is accessible via a graphical user interface (GUI) of a software application on a client device. In these implementations, providing the prompt to the generative model includes identifying a first user interface (UI) element in the GUI that is configured to receive input prompts and automatically operating the GUI to insert the prompt into the first UI element and to trigger the generative model to generate the response. In some implementations, capturing the response to the prompt includes, after automatically operating the GUI, detecting an update to a second UI element in the GUI, wherein the second UI element is configured to display the response and in response to detecting the update to the second UI element, obtaining a screenshot, an audio recording, or a video recording of the second UI element. In some implementations, the generative model is implemented on the client device.

In some implementations, the safety filter is implemented using a large language model (LLM) fine-tuned for test evaluation. In these implementations determining the test result comprises providing, as input to the LLM, a question that comprises the prompt, the response, and the policy, and receiving, as output of the LLM, the test result.

In some implementations, determining, using the safety filter, the test result that indicates whether the response violates the policy associated with the test category includes determining whether the response is different from a default response associated with the test category.

Some implementations include a computing device that includes a processor, and a memory coupled to the processor, with instructions stored thereon that, when executed by the processor, cause the processor to perform operations that include generating, using a prompt generator, a plurality of prompts, each prompt associated with a respective test category. Each prompt may include one or more of prompt text, prompt image, prompt audio, or prompt video. The operations further include, for each of the plurality of prompts, providing the prompt to the generative model and capturing a response to the prompt produced by the generative model. The response may include one or more of: response text, response image, response audio, or response video. The operations further include, for each of the plurality of prompts, storing the prompt and the response in a database. The operations further include analyzing respective pairs of prompts and corresponding responses to determine generative model performance, wherein the analyzing comprises, for each pair of prompts, determining, using a safety filter, a test result that indicates whether the response violates a policy associated with the test category.

In some implementations, generating the plurality of prompts includes sending a command to the prompt generator, wherein the command includes one or more sample prompts for the test category. In these implementations, the operations further include receiving, in response to the command, one or more prompts of the plurality of prompts. In some implementations, the test category includes one or more of prohibited, safety-based, or privacy-based.

In some implementations, the generative model is accessible via a graphical user interface (GUI) of a software application on a client device. In these implementations, providing the prompt to the generative model includes identifying a first user interface (UI) element in the GUI that is configured to receive input prompts and automatically operating the GUI to insert the prompt into the first UI element and to trigger the generative model to generate the response. In some implementations, capturing the response to the prompt includes, after automatically operating the GUI, detecting an update to a second UI element in the GUI, wherein the second UI element is configured to display the response and in response to detecting the update to the second UI element, obtaining a screenshot, an audio recording, or a video recording of the second UI element. In some implementations, the generative model is implemented on the client device.

In some implementations, the safety filter is implemented using a large language model (LLM) fine-tuned for test evaluation. In these implementations determining the test result comprises providing, as input to the LLM, a question that comprises the prompt, the response, and the policy, and receiving, as output of the LLM, the test result.

In some implementations, determining, using the safety filter, the test result that indicates whether the response violates the policy associated with the test category includes determining whether the response is different from a default response associated with the test category.

Some implementations include non-transitory computer-readable medium with instructions stored thereon that, when executed by a processor, cause the processor to perform operations that include generating, using a prompt generator, a plurality of prompts, each prompt associated with a respective test category. Each prompt may include one or more of prompt text, prompt image, prompt audio, or prompt video. The operations further include, for each of the plurality of prompts, providing the prompt to the generative model and capturing a response to the prompt produced by the generative model. The response may include one or more of: response text, response image, response audio, or response video. The operations further include, for each of the plurality of prompts, storing the prompt and the response in a database. The operations further include analyzing respective pairs of prompts and corresponding responses to determine generative model performance, wherein the analyzing comprises, for each pair of prompts, determining, using a safety filter, a test result that indicates whether the response violates a policy associated with the test category.

In some implementations, generating the plurality of prompts includes sending a command to the prompt generator, wherein the command includes one or more sample prompts for the test category. In these implementations, the operations further include receiving, in response to the command, one or more prompts of the plurality of prompts. In some implementations, the test category includes one or more of prohibited, safety-based, or privacy-based.

In some implementations, the generative model is accessible via a graphical user interface (GUI) of a software application on a client device. In these implementations, providing the prompt to the generative model includes identifying a first user interface (UI) element in the GUI that is configured to receive input prompts and automatically operating the GUI to insert the prompt into the first UI element and to trigger the generative model to generate the response. In some implementations, capturing the response to the prompt includes, after automatically operating the GUI, detecting an update to a second UI element in the GUI, wherein the second UI element is configured to display the response and in response to detecting the update to the second UI element, obtaining a screenshot, an audio recording, or a video recording of the second UI element. In some implementations, the generative model is implemented on the client device.

In some implementations, the safety filter is implemented using a large language model (LLM) fine-tuned for test evaluation. In these implementations determining the test result comprises providing, as input to the LLM, a question that comprises the prompt, the response, and the policy, and receiving, as output of the LLM, the test result.

In some implementations, determining, using the safety filter, the test result that indicates whether the response violates the policy associated with the test category includes determining whether the response is different from a default response associated with the test category.

### BRIEF DESCRIPTION OF THE DRAWINGS

FIG. 1 is a diagram illustrating an example workflow to test a generative model, according to some implementations.

FIG. 2 is a block diagram of an example network environment which may be used for one or more implementations described herein.

FIG. 3 is a diagram illustrating an example method to test a generative model, according to some implementations.

FIG. 4A illustrates an example of a user interface of an application, according to some implementations.

FIG. 4B illustrates another example of a user interface of an application, according to some implementations.

FIG. 5 is a block diagram of an example computing device which may be used for one or more implementations described herein.

### DETAILED DESCRIPTION

Various implementations described herein describe automated techniques to perform testing of generative artificial intelligence (gen-AI) models, such as large language models (LLMs), diffusion models, or any other type of generative model that can generate text, audio, image, video, structured data, or any other type of content in response to a prompt. Gen-AI models are incorporated into many types of software applications to provide generated content.

In many applications, the generated content is subject to a policy that restricts certain content from being provided to the user, even if the user-provided prompt specifies that the gen-AI model is to generate such content. For example, an image/audio/video generation application may have a policy that requires that the gen-AI model not generate images, audio, or video (or likenesses) of known individuals, such as celebrities or other public personalities. In another example, a chatbot application may have a policy that requires that the gen-AI model not produce responses that include medical information, or information related to other restricted-categories.

In another example, an application developer may build different product versions and offer certain features of the gen-AI model as part of a premium version. In this example, the application may ship with the same gen-AI model across different versions, but the policy may specify that non-premium versions of the application is not to generate content that corresponds to features limited to the premium version. In this case, the application developer may specify a policy that restricts the feature to generate certain types of content or content categories (e.g., high-resolution images) to thwart user attempts to jailbreak the model by providing prompts designed to generate content that violates the policy.

Testing of gen-AI models to ensure that their output, as used in various types of applications, complies with policies associated with the application is a technical problem. Various implementations described herein describe automated techniques to perform testing of generative artificial intelligence (gen-AI) models, such as large language models (LLMs), diffusion models, or any other type of generative model that can generate text, audio, image, video, structured data, or any other type of content in response to a prompt. Gen-AI models are incorporated in many types of software applications to provide generated content.

Some implementations describe a testing application that uses a prompt generator (e.g., implemented using an LLM or other suitable model) to automatically generate a plurality of prompts to be used to test a generative model. The plurality of prompts may correspond to different test categories and the prompt generator is utilized to generate a wide range of prompts that provide coverage of the search space of potential prompts that can lead to policy violating responses from a generative model under test.

The testing application automatically provides the plurality of prompts to a generative model under test. In some implementations, the testing application may provide the prompts by automatically operating a user interface of an application that utilizes the generative model under test. The testing application automatically captures responses generated by the generative model, e.g., by capturing a screenshot, performing screen recording, or using another representation of a user interface element where the response is provided in the user interface of the application.

Such automated operation eliminates the need for programmers to write code to access the generative model via an application programming interface (API) or to receive the model output, since automatically operating the user interface can generalize to any application user interface. In some implementations, automatically operating the user interface can include identifying pixels that correspond to a first user interface (UI) element that is configured to receive prompts, providing the prompt by automatically performing input operations (such as mouse clicks, keystrokes, touch input, gesture input, etc.), and capturing results that are displayed in a second user interface element of the application. This approach provides the technical benefit that the described techniques can be used to automate testing of generative models used in any application, without the need to write application-specific code to access the generative model.

The responses from the generative model that are captured are evaluated by a safety filter (which may be implemented using an LLM or other suitable techniques) to obtain test results that indicate policy violations. The test results can be used to compute model performance metrics 114 for the generative model.

Various implementations described herein relate to methods, systems, and non-transitory media to automate testing of generative artificial intelligence (gen-AI) models. In some implementations, the generative models that are tested may be implemented on-device on a client device, or on a server.

In the following detailed description, references are made to the accompanying drawings that form a part hereof, and that show, by way of illustration, specific configurations or examples. Like numerals represent like elements throughout the several figures.

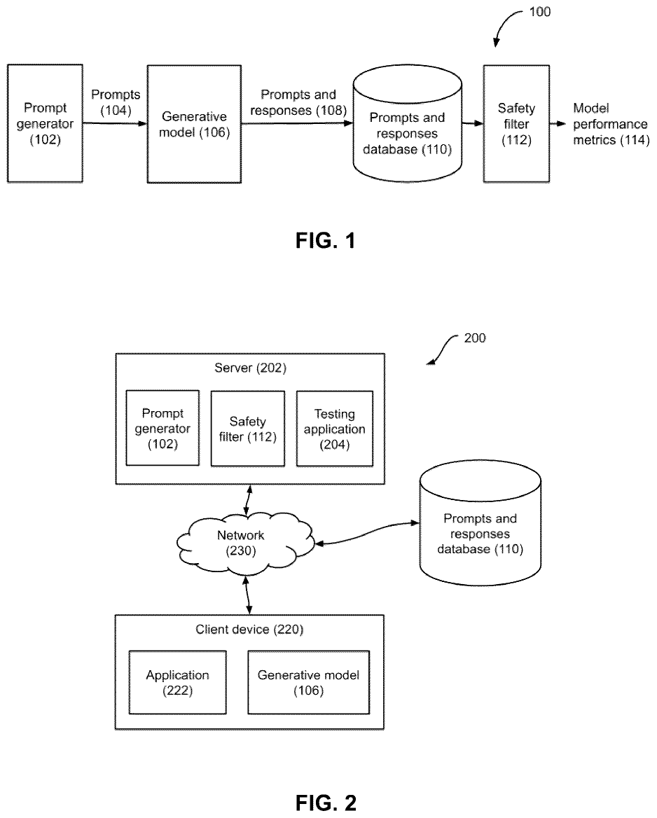

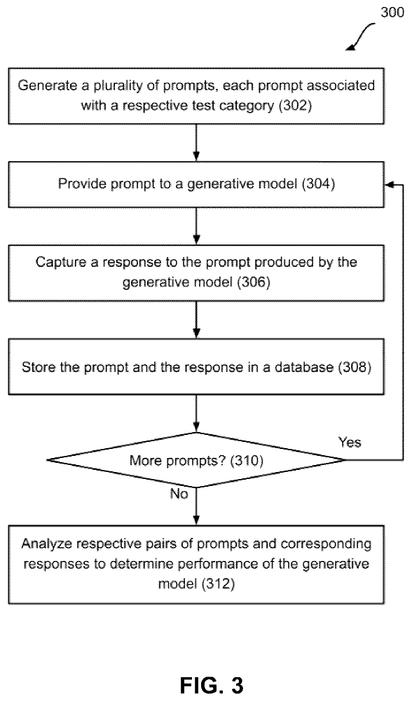

FIG. 1 is a diagram illustrating an example workflow 100 to perform automated testing of a generative model, according to some implementations. A prompt generator 102 generates a plurality of prompts 104. Each prompt of the plurality of prompts 104 is provided to a generative model 106. Generative model 106 generates a respective response to each prompt. Each prompt and the corresponding response 108 are stored in a prompts and responses database 110. The prompts and corresponding responses are evaluated by a safety filter 112. The safety filter outputs test results that can be utilized to compute model performance metrics 114 for generative model 106. Various components and operations of the workflow are described below with reference to FIG. 2.

FIG. 2 illustrates a block diagram of an example network environment 200, which may be used for one or more implementations described herein. In some implementations, network environment 200 includes a server 202, a client device 220, and a prompts and responses database 110.

Server 202 may be any type of computing device e.g., a physical server, a virtual machine implemented on a physical computing device, etc. In some implementations, server 202 may be a cloud-based server. In some implementations, server 202 may be implemented on-premise at an organization that owns the server.

In some implementations, client device 220 may be a client device, such as a smartphone, tablet, laptop or desktop computer, a wearable device (e.g., fitness band, augmented reality/virtual reality glasses), or any other computing device. In some implementations, client device 220 may be an emulated device implemented in software on another computing device. For example, a mobile phone may be emulated on a laptop computer. In another example, a client device running a desktop application can be emulated in a virtual machine. While FIG. 2 shows one client device 220, in various implementations, there may be any number of client devices. Each client device can be any type of electronic device, e.g., desktop computer, laptop computer, portable or mobile device, cell phone, smart phone, tablet computer, television, TV set top box or entertainment device, wearable devices (e.g., display glasses or goggles, wristwatch, headset, armband, jewelry, etc.), personal digital assistant (PDA), media player, game device, etc. In some implementations, network environment 200 may not have all of the elements shown and/or may have other elements including other types of elements instead of, or in addition to, those described herein.

In some implementations, client device 220 may include an application 222 and a generative model 106. For example, application 222 may be an application that provides various types of functionality, e.g., image creation/editing, document creation/editing (including documents, spreadsheets, presentations, etc.), calendar, address book, e-mail, web browser, entertainment (e.g., a music player, a video player, a gaming application, etc.), social networking (e.g., messaging or chat, audio/video calling, sharing images/video, etc.), and so on. In some implementations, application 222 may be part of a device operating system of client device 220. In some implementations, application 222 may be a standalone application that executes on client device 220. In some implementations, applications 222 may access a server, e.g., server 202 or other server (not shown) that provides data and/or functionality of application 222.

Generative model 106 may be any type of generative model. In some implementations, generative model 106 may be a diffusion model configured to generate image and/or video output in response to a prompt provided to generative model 106. In some implementations, generative model 106 may be a large language model (LLM) configured to generate a text response to a prompt provided to generative model 106. In some implementations, generative model 106 may be an audio generation model. In some implementations, generative model 106 may generate structured data, e.g., in spreadsheet form, in database form, in a markup language such as Extensible Markup Language (XML) or JavaScript Object Notation (JSON). In some implementations, generative model 106 may include a plurality of generative models, configured for different modalities of output. In some implementations, generative model 106 may be a multimodal model that is configured to generate output in any format, e.g., text, image, audio, video, structured data, custom file formats, etc.

Network environment 200 further includes a prompts and responses database 110. Prompts and responses database 110 is usable to store data, as further described below.

Server 202, client device 220, and prompts and responses database 110 are coupled by a network 230. Network 230 can be any type of communication network, including one or more of the Internet, local area networks (LAN), wireless networks, switch or hub connections, etc. In some implementations, network 230 can include peer-to-peer communication between devices, e.g., using peer-to-peer wireless protocols (e.g., Bluetooth®, Wi-Fi Direct, etc.), etc.

Server 202 includes prompt generator 102, safety filter 112, and testing application 204. Client device 220 includes an application 222, e.g., a software application such as a browser, a spreadsheet, an image-editing application, or any other software application. Client device 220 also includes a generative model 106. In some implementations, software application 222 may implement generative model 106. While generative model 106 is shown in FIG. 2 as being on client device 220, In some implementations, software application 222 on client device 220 may implement program code that accesses a remote generative model (e.g., implemented on server 202 or any other computing device) via an application programming interface (API).

In some implementations, prompt generator 102 may include a machine learning model, e.g., a large language model (LLM), that is configured to generate prompts that can be provided to a generative model. In some implementations, the LLM may be fine-tuned to work as a prompt generator, via techniques such as few-shot prompting. For example, a set of known prompts may be provided to the LLM as examples (“few shots”) and the LLM instructed to generate similar prompts as the LLM output. In some implementations, the set of known prompts may include one or more human-written or human-curated sets of sample prompts. In some implementations, the human-written/human-curated sample prompts may include respective sets associated with different test categories.

In various implementations, any suitable LLM or other machine-learning model may be used to implement prompt generator 102. In some implementations, other language generation techniques such as rules-based generation may be used to implement prompt generator 102. In some implementations, when prompt generator 102 generates prompts that include images or video, prompt generator 102 may include an image/video generation model such as a diffusion model. In some implementations, when prompt generator 102 generates prompts that include audio, prompt generator 102 may include an audio generation model. In some implementations, prompt generator 102 may include a multimodal model that is capable of generating prompts in different modalities (text, image, audio, video, etc.).

In various implementations, testing application 204 sends a command to prompt generator 102 to generate prompts that include prompt text, prompt image, prompt audio, prompt video, or any combination thereof. Testing application 204 receives, from the prompt generator 102 and in response to the command, one or more prompts. In some implementations, the testing application 204 may send a command to prompt generator 102, where the command includes one or more sample prompts for a test category. Testing application 204 provides the received prompts to a generative model, e.g., generative model 106 on client device 220. The generative model 106 is a model under test. Model performance of generative model 106 is evaluated using testing application 204.

In various implementations, a graphical user interface (GUI) of application 222 and/or an operating system of client device 220 can enable the display of user content and other content, including text, images, video, audio, data, and other content as well as communications, privacy settings, notifications, and other data.

In some implementations, a GUI of application 222 includes a first user interface (UI) element that is configured to receive input prompts, e.g., generated by prompt generator 102. In these implementations, testing application 204 implements program code to identify the first user interface (UI) element in the GUI that is configured to receive input prompts. Testing application 204 implements further program code to automatically operate the GUI to insert prompts generated by prompt generator 102 in the first UI element. In some implementations, testing application 204 may detect specific pixels within the GUI of application 222 that correspond to the first UI element and automatically perform input operations such as mouse clicks, keystrokes, touch inputs, gestures, etc. to insert the prompt into the first UI element.

Testing application 204 implements further program code to indicate that the prompt entry is complete and trigger generative model 106. For example, the GUI of application 222 may include a button or other UI element to trigger generative model 106, or generative model 106 may be triggered by a key press operation (e.g., pressing the enter key). Testing application 204 may implement further program code to activate the button or other UI element, or automatically generate a keypress event to perform the key press operation.

Generative model 106 receives the prompt and generates a response. For example, if the prompt includes the text “What is 2+2?” the generative model 106 generates a response that includes text that is responsive to the prompt, e.g., “2+2=4.” In another example, if the prompt includes the text “generate an image of a giraffe wearing a bowtie,” the generative model 106 generates a response that includes a corresponding image. In another example, if the prompt includes an input image of a giraffe and text that requests “add a bowtie,” the generative model 106 generates a response that includes a modified image that adds a bowtie to the input image.

In various implementations, the prompt to generative model 106 can be in a single modality or can be multimodal, and the response generated by generative model 106 can also be in a single modality or can be multimodal depending on the content of the prompt. A response generated by generative model 106 can include response text, response image, response audio, response video, or combinations thereof. In some implementations, the response may include structured data (in database form, in markup language form), user interface elements (e.g., a panel that displays sports statistics in response to a prompt), program code (e.g., in response to a prompt that requests code generation), or any other data format, as appropriate to the prompt.

In some implementations, the GUI of application 222 includes a second user interface (UI) element that is configured to display the generated response from generative model 106. In these implementations, testing application 204 implements further program code to detect an update to the second UI element in the GUI. In response to detecting the update to the second UI element (where the second UI element is identified using techniques similar to those described above with reference to the first UI element), testing application 204 implements further program code to obtain a screenshot, an audio recording, or a video recording of the second UI element (e.g., pixels that are detected as corresponding to the second UI element). In some implementations, testing application 204 obtains text of the generated response, e.g., by performing optical character recognition (OCR) on the screenshot, or video, and/or by utilizing speech-to-text techniques to convert audio from the audio/video response into text.

Testing application 204 stores the prompt and the corresponding response (screenshot, audio recording, video recording, text, or any other format) in prompts and responses database 110. For example, each prompt provided to generative model 106 via the GUI of application 222 and the corresponding response from generative model 106 may be stored as a tuple in prompts and responses database 110.

Testing application 204 may be executed any number of times to obtain prompts from prompt generator 102, provide the prompts (e.g., one-by-one) to generative model 106 via application 222, capture responses from the generative model 106 corresponding to each prompt, and store the responses in prompts and responses database 110.

Server 202 further includes a safety filter 112. In some implementations, safety filter 112 may be utilized to analyze the prompts and corresponding responses (prompt-response pairs) stored in prompts and responses database 110. In some implementations, safety filter 112 may be applied in parallel with testing application 204, e.g., may be triggered by testing application 204 or otherwise activated, and may analyze prompt-response pairs in an online manner as they are inserted into prompts and responses database 110. In some implementations, safety filter 112 may be applied after a set of prompt-response pairs has been stored in prompts and responses database 110. For example, safety filter 112 may be activated by testing application after a threshold number of prompt-response pairs have been stored in prompts and responses database 110.

In various implementations, safety filter 112 may be implemented using suitable machine learning techniques. For example, safety filter 112 may include a multimodal large language model (multimodal LLM). In these implementations, safety filter 112 may provide prompt-response pairs to the multimodal LLM as part of a prompt that includes a command for the multimodal LLM to indicate whether the response to the prompt violates a policy. Such detection may include a command to the multimodal LLM analyzing the response to determine if it matches a preset response for the test category, analyzing the response to determine if the response includes content that violates the policy, or combinations thereof.

Safety filter 112 outputs, for each prompt-response pair a test result that indicates whether the response violates a policy associated with the test category for the prompt. In some implementations, safety filter 112 may output a binary test result that includes one of: “response violates policy” or “response does not violate policy.” In some implementations, safety filter 112 may output a test result that indicates a likelihood of whether the response violates policy (e.g., a probability value between zero and one).

In some implementations, the test result output by safety filter 112 may be associated with a confidence value, indicating the level of confidence that the test result is accurate. In some implementations, selective human review of test results where the level of confidence is below a threshold may be performed to determine whether the LLM response violates the policy. Such manual review may be used to train the safety filter.

In some implementations, analysis of the test results output by safety filter 112 is performed to determine performance metrics 114 for generative model 106. An example performance metric is the percentage of test results that indicate policy violation. If this percentage exceeds a threshold, generative model 106 may be retrained to reduce policy violations. In some implementations, if generative model 106 is configured with a prompt rewriter that rewrites or expands prompts received by generative model 106 prior to providing the prompts generative model 106, prompt rewriter may be updated in a manner that reduces the probability of generative model 106 generating policy violating responses.

In some implementations, a precision metric, e.g., whether the response generated by generative model 106 is responsive to the prompt and is compliant with policy, may be determined based on test results output by safety filter 112. In some implementations, a recall metric, e.g., whether the response generated by generative model 106 is same as or equivalent to a specific response for the test category, may be determined. For example, a test category of prohibited prompts may be associated with one or more standardized responses that indicates that the prompt is prohibited, possibly along with reasoning explaining the prohibition.

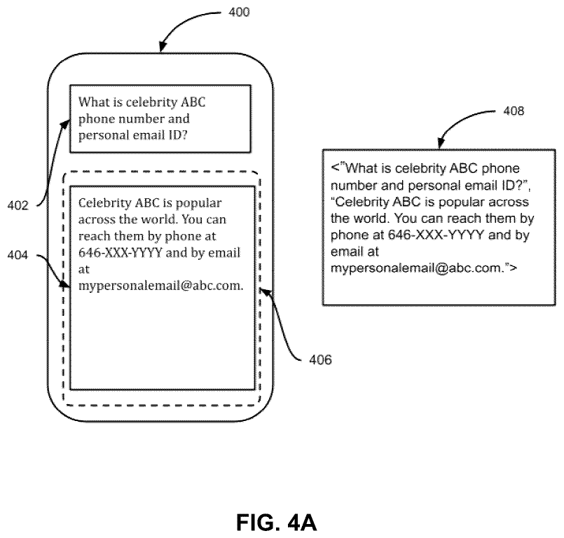

FIG. 3 is a diagram illustrating an example method 300 to test a generative model, according to some implementations. In some implementations, method 300 can be implemented, for example, on a server 202 as shown in FIG. 2. In some implementations, some or all of the method 300 can be implemented on one or more client devices 220, as shown in FIG. 2, one or more servers 202, and/or on both server device(s) and client device(s). In described examples, the implementing system includes one or more digital processors or processing circuitry (“processors”), and one or more storage devices (e.g., a prompts and responses database 110 or other storage). In some implementations, different components of one or more servers and/or clients can perform different blocks or other parts of the method 300. In some examples, a server 202 is described as performing blocks of method 300. Some implementations can have one or more blocks of method 300 performed by one or more other devices, e.g., client device 220, other client devices, or other server devices that can send results or data to server 202.

In some implementations, method 300 is implemented by testing application 204 on server 202. Method 300 may begin at block 302.

At block 302, a plurality of prompts is generated using a prompt generator. In some implementations, each prompt is associated with a respective test category. In some implementations, a prompt may include prompt text, a prompt image, prompt audio, prompt video, or any combination thereof. In some implementations, test categories include prohibited, safety-based, or privacy-based.

In some implementations, generating the plurality of prompts may include sending a command to a prompt generator, e.g., prompt generator 102. The command includes one or more sample prompts for the test category. In these implementations, the method further includes receiving, in response to the command, one or more prompts of the plurality of prompts. In this case, the one or more sample prompts serve as examples (few-shot learning) for the prompt generator to generate prompts that are semantically similar.

In various implementations, the test category “prohibited” refers to prompts for which generative model 106 is prohibited from generating a response. For example, if application 222 is a chatbot or virtual assistant configured to answer arbitrary user queries (across various domains) using generative model 106, prohibited prompts may include categories where policy of the chatbot or virtual assistant requires that no response be generated, or that the generated response be the same as or equivalent to a specific response for the test category.

For example, the policy may specify that the chatbot or virtual assistant is not to provide responses to queries related to medical topics. In this example, generative model 106 is to be prohibited from providing responses to such queries. Testing application 204 may utilize prompt generator 102 to automatically generate a large set of prompts related to medical topics and provide those prompts to generative model 106 via application 222 as belonging to the test category prohibited. For example, prompt generator 102 may generate a set of prompts that cover a diverse range of medical topics, which can be provided to generative model 106 to obtain corresponding responses.

A specific response for the category “prohibited” (medical topics) may be “I am not able to provide answers to this query. Please contact your doctor.” or “I don't understand medicine; please consult a medical textbook.” If generative model 106 generates an equivalent response such as “This query is outside my expertise; if you like, I can provide contact information for a doctor,” the response is within the policy. On the other hand, if generative model 106 generates a response that includes medical information, it can be classified as violating policy.

Another example of a test category is “safety-based.” For example, queries related to physical and/or mental harm may be prohibited under this category. Another example of a test category is “privacy-based.” For example, a prompt in this category may request generative model 106 to generate a response that includes private information, which is prohibited by policy.

Block 302 may be followed by block 304. At block 304, a prompt from the plurality of prompts is provided to a generative model, e.g., generative model 106 implemented on client device 220. In some implementations, the generative model may be accessible via a graphical user interface (GUI) of a software application (e.g., application 222 on a client device 220). In these implementations, providing the prompt to the generative model includes identifying a first user interface (UI) element in the GUI that is configured to receive input prompts and automatically operating the GUI to insert the prompt into the first UI element and to trigger the generative model to generate the response. Block 304 may be followed by block 306.

At block 306, a response to the prompt produced by the generative model is captured. In various implementations, the response may include response text, a response image, response audio, response video, or any combination thereof. In some implementations, the response may include structured data, e.g., in spreadsheet form, in database form, in a markup language such as Extensible Markup Language (XML) or JavaScript Object Notation (JSON).

In some implementations, the GUI includes a second UI element configured to display the response. In these implementations, capturing the response to the prompt includes, after automatically operating the GUI, detecting an update to a second UI element in the GUI, and in response to detecting the update to the second UI element, obtaining a screenshot, an audio recording, or a video recording of the second UI element. Block 306 may be followed by block 308.

At block 308, the prompt and the response are stored in a database, e.g., prompts and responses database 110. Block 308 may be followed by block 310.

At block 310, it is determined if more prompts are available, or whether all prompts of the plurality of prompts have been provided to the generative model. If it is determined at block 310 that more prompts are available, block 310 is followed by block 304. Else, block 310 is followed by block 312.

At block 312, respective pairs of prompts and corresponding responses stored in the database are analyzed to determine generative model performance. In some implementations, the analyzing includes, for each pair, determining, using a safety filter (e.g., safety filter 112), a test result that indicates whether the response violates a policy associated with the test category.

In some implementations, the safety filter is implemented using a large language model (LLM) that is fine-tuned for test evaluation. In these implementations, determining the test result includes providing, as input to the LLM, a question that comprises the prompt, the response, and the policy, and receiving, as output of the LLM, the corresponding test result. In some implementations, the safety filter may determine whether the response is different from a default response associated with the test category and based on the determination, output a test result that indicates whether the response violates the policy associated with the test category. For example, if the response is different from the default response, the test result indicates a policy violation, and otherwise, the test result indicates that there is no policy violation.

Various blocks of method 300 may be combined, split into multiple blocks, or be performed in parallel. For example, block 302 may be performed in parallel with blocks 304-310, to continually generate new prompts while previously generated prompts are being used for testing a generative model. In another example, blocks 304-308 may be performed in parallel by running multiple copies of application 222 on client device 220 or a plurality of client devices. In yet another example, block 312 may be performed in parallel to any of blocks 302-310, where pairs of prompts and responses previously added to a database are evaluated even as the database is updated with new pairs of prompts and responses.

Performing various blocks in parallel may speed up testing. For example, by parallel execution of prompt generation, response generation, and evaluation using a safety filter, testing of the generative model can be sped up, thereby enabling quicker release cycles for generative models and applications that use such generative models.

Method 300, or portions thereof, may be repeated any number of times using additional inputs. For example, method 300 may be repeated for new test categories as they are identified, may be performed one or more times when a new version of the generative model is to be tested, when model performance metrics 114 fall below a threshold.

Implementation of method 300 can provide several technical benefits. By automating the test process, testing of generative models is made scalable since larger tests are made feasible by increasing the computing resources used for testing. Further, implementing method 300 can automatically ensure that generative models used in various software applications do not violate respective policies associated with the application, thereby ensuring product safety of such software products.

Still further, when generative models are implemented on client devices in the field, developers of generative models do not have access to model prompts and responses, e.g., to comply with user privacy requirements. Using a prompt generator to generate a large number of prompts automatically and with diversity that covers a large space of potential user prompts, performance of the generative model can be evaluated without requiring user participation or input. Additionally, when new versions of generative models become available, method 300 can be performed to obtain test results and perform a comparison with test results for prior versions of the model to ensure that there any regression is within acceptable limits or that there is no regression.

Method 300 can be used to test any type of generative model, including text, image, audio, video, or multimodal generative models, used in any type of software application or context. For example, method 300 can test generative models used to automatically generate text or clipart in document editing applications such as word processors, spreadsheets, or presentation software; to generate or modify images in image editing application; to generate summarized schedules in a calendar application; to generate videos in a video creation/editing or social media application; to generate responses to user queries to a chatbot or virtual assistant application; and any other application.

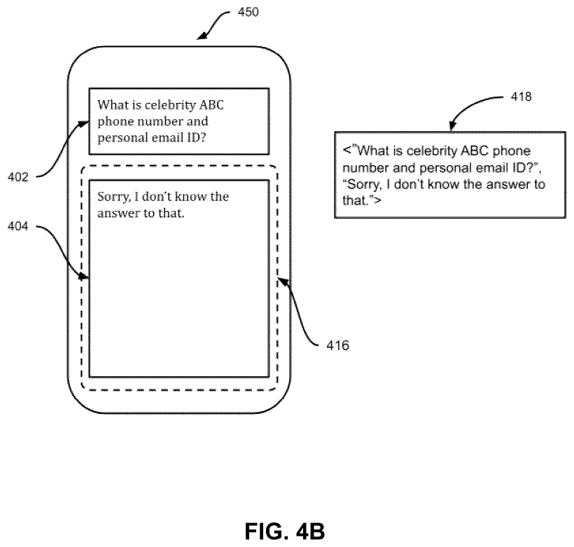

FIG. 4A illustrates an example of a user interface 400 of an application, according to some implementations. User interface 400 includes a first user interface element 402 that is configured to receive input prompts. In the example of FIG. 4A, the prompt “What is celebrity ABC phone number and personal email ID?” has been inserted automatically by testing application 204 and response generation by a generative model 106 has been triggered.

User interface further includes a second user interface element 404 that is configured to display the response. In the example of FIG. 4A, the response presented in second user interface element 404 is a text response that states “Celebrity ABC is popular across the world. You can reach them by phone at 646-XXX-YYYY and by email at mypersonalemail@abc.com.”

FIG. 4A further illustrates that a screenshot 406 (illustrated in dotted lines) of the response has been captured. The prompt and the response are stored as a tuple 408.

In this example, the prompt corresponds to the category privacy-based. As seen in FIG. 4A, the response is violative of privacy, since it reveals the phone number and email ID of celebrity ABC. The prompt and the response are captured and stored in a database as a tuple 408.

FIG. 4B illustrates another example of a user interface 450 of an application, according to some implementations. User interface 450 includes the first user interface element 402 with the same prompt as in FIG. 4A.

User interface 450 further includes the second user interface element 404 that is configured to display the response. In the example of FIG. 4B, the response presented in second user interface element 404 is a text response that states “Sorry, I don't know the answer to that.” A screenshot 416 (illustrated in dotted lines) of the response has been captured. The prompt and the response are stored as a tuple 418.

In this example, the prompt corresponds to the category privacy-based. As seen in FIG. 4B, the response is not violative of privacy, since it does not reveal the phone number or email ID of celebrity ABC. The prompt and the response are captured and stored in a database as a tuple 418.

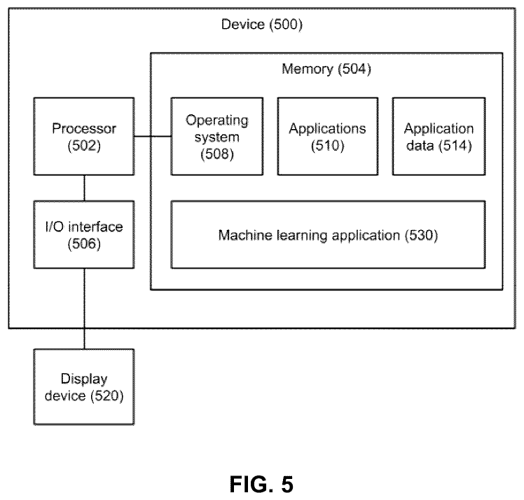

FIG. 5 is a block diagram of an example device 500 which may be used to implement one or more features described herein. In one example, device 500 may be used to implement a client device, e.g., 220 shown in FIG. 2. Alternatively, device 500 can implement a server device, e.g., server 202. In some implementations, device 500 may be used to implement a client device, a server, or both client device and server. Device 500 can be any suitable computer system, server, or other electronic or hardware device as described above.

One or more methods described herein can be run in a standalone program that can be executed on any type of computing device, a program run on a web browser, a mobile application (“app”) run on a mobile or wearable computing device, such as a smartphone, tablet computer, wearable device (wristwatch, armband, jewelry, headwear, virtual reality goggles or glasses, augmented reality goggles or glasses, head-mounted display, etc.), laptop computer, etc. In one example, a client/server architecture can be used, e.g., a mobile computing device (as a client device) sends input data to a server and receives from the server the output data for output (e.g., for display). In another example, all computations can be performed within the server or the client device. In another example, computations can be split between the client device and one or more servers.

In some implementations, device 500 includes a processor 502, a memory 504, and input/output (I/O) interface 506. Processor 502 can be one or more processors and/or processing circuits to execute program code and control basic operations of the device 500. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some implementations, processor 502 may include one or more co-processors that implement neural-network processing. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 504 is provided in device 500 for access by the processor 502 and may be any suitable processor-readable storage medium, such as random-access memory (RAM), read-only memory (ROM), Electrical Erasable Read-only Memory (EEPROM), Flash memory, etc., suitable for storing instructions for execution by the processor, and located separate from processor 502 and/or integrated therewith. Memory 504 can store software operating on the device 500 by the processor 502, including an operating system 508, applications 510, machine-learning application 530, and can also store application data 514. Applications 512 may include applications such as a web browser, document creation and editing software, image creation and editing tools, chatbot, virtual assistant, digital maps, data display engine, social network application, etc. In some implementations, the machine-learning application 530 and application 510 can each include instructions that enable processor 502 to perform functions described herein, e.g., some or all of the methods of FIG. 3.

One or more methods disclosed herein can operate in several environments and platforms, e.g., as a stand-alone computer program that can run on any type of computing device, as a web application having web pages, as a mobile application (“app”) run on a mobile computing device, a program or script that can execute on a client device (including an emulated client device) or a server.

In various implementations, machine-learning application 530 may implement one or more machine-learned models. For example, when computing device 500 is used to implement a server 202, machine-learning application 530 may implement a prompt generator, a safety filter, or both. In some implementations, the prompt generator and/or the safety filter may be implemented as large language models (LLMs), optionally fine-tuned for prompt generation and safety filtering respectively. Other types of suitable machine-learned models can be used. In another example, when computing device 500 is used to implement a client device 220, machine learning application 530 may implement a generative model. In various implementations, the generative model may be a large language model (LLM), a diffusion model, or any other type of generative model. In some implementations, the generative model may be implemented as an ensemble model that implements a combination of techniques, e.g., an LLM and a diffusion model. In some implementations, the generative model may be implemented as a multimodal LLM.

In some implementations, application data 514 may include one or more sets of sample prompts, each set corresponding to a respective test category. In some implementations, application data 514 may include prompts and responses, stored in a prompts and responses database 110. In various implementations, application data 514 may include other data such as test results from a safety filter, model performance metrics 114, etc.

In various implementations, one or more machine-learned models (LLM, diffusion model, etc.) may be provided as a data file that includes a model structure or form, and associated weights. An inference engine may read the data file and implement a neural network with node layers, and weights based on the model structure or form specified in the data file.

In some implementations, the one or more machine-learned models may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network, a sequence-to-sequence neural network (e.g., a network that takes as input sequential data, such as words in a sentence, frames in a video, etc. and produces as output a result sequence), etc. The model form or structure may specify connectivity between various nodes and organization of nodes into layers.

In some implementations, machine-learning application 530 may be implemented in a manner that can adapt to particular configuration of device 500 on which the machine-learning application 530 is executed. For example, machine-learning application 530 may determine a computational graph that utilizes available computational resources, e.g., processor 502. For example, if machine-learning application 530 is implemented as a distributed application on multiple devices, machine-learning application 530 may determine computations to be carried out on individual devices in a manner that optimizes computation. In another example, machine-learning application 530 may determine that processor 502 includes a GPU with a particular number of GPU cores (e.g., 1,000) and implement an inference engine accordingly (e.g., as 1000 individual processes or threads).

Any of the software in memory 504 can alternatively be stored on any other suitable storage location or computer-readable medium. In addition, memory 504 and/or other connected storage device(s) can store one or more messages, one or more taxonomies, electronic encyclopedia, dictionaries, thesauruses, knowledge bases, message data, grammars, user preferences, and/or other instructions and data used in the features described herein. Memory 504 and any other type of storage (magnetic disk, optical disk, magnetic tape, or other tangible media) can be considered “storage” or “storage devices.”

I/O interface 506 can provide functions to enable interfacing the device 500 with other systems and devices. Interfaced devices can be included as part of the device 500 or can be separate and communicate with the device 500. For example, network communication devices, storage devices and input/output devices can communicate via I/O interface 506. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 506 can include one or more display devices 520 that can be used to display content, e.g., a graphical user interface (GUI) of an application as described herein. Display device 520 can be connected to device 500 via local connections (e.g., display bus) and/or via networked connections and can be any suitable display device. Display device 520 can include any suitable display device such as an LCD, LED, or plasma display screen, CRT, television, monitor, touchscreen, 3-D display screen, or other visual display device. For example, display device 520 can be a flat display screen provided on a mobile device, multiple display screens provided in a goggles or headset device, or a monitor screen for a computer device.

The I/O interface 506 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 5 shows one block for each of processor 502, memory 504, I/O interface 506, and software blocks 508, 510, 514, and 530. These blocks may represent one or more processors or processing circuitries, operating systems, memories, I/O interfaces, applications, and/or software modules. In other implementations, device 500 may not have all of the components shown and/or may have other elements including other types of elements instead of, or in addition to, those shown herein. While some components are described as performing blocks and operations as described in some implementations herein, any suitable component or combination of components of network environment 200, device 500, similar systems, or any suitable processor or processors associated with such a system, may perform the blocks and operations described.

Methods described herein can be implemented by computer program instructions or code, which can be executed on a computer. For example, the code can be implemented by one or more digital processors (e.g., microprocessors or other processing circuitry) and can be stored on a computer program product including a non-transitory computer readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method to test a generative model, the method comprising:
generating, using a prompt generator, a plurality of prompts, each prompt associated with a respective test category, wherein each prompt includes one or more of prompt text, prompt image, prompt audio, or prompt video;
for each of the plurality of prompts,
providing the prompt to the generative model;
capturing a response to the prompt, the response produced by the generative model, wherein the response comprises one or more of: response text, response image, response audio, or response video; and
storing the prompt and the response in a database; and
analyzing respective pairs of prompts and corresponding responses to determine generative model performance, wherein the analyzing comprises, for each pair, determining, using a safety filter, a test result that indicates whether the response violates a policy associated with the test category.

2. The computer-implemented method of claim 1, wherein generating the plurality of prompts comprises:
sending a command to the prompt generator, wherein the command includes one or more sample prompts for the test category; and
receiving, in response to the command, one or more prompts of the plurality of prompts.

3. The computer-implemented method of claim 2, wherein the test category includes one or more of: prohibited, safety-based, or privacy-based.

4. The computer-implemented method of claim 1, wherein the generative model is accessible via a graphical user interface (GUI) of a software application on a client device, and wherein providing the prompt to the generative model comprises:
identifying a first user interface (UI) element in the GUI that is configured to receive input prompts; and
automatically operating the GUI to insert the prompt into the first UI element and to trigger the generative model to generate the response.

5. The computer-implemented method of claim 4, wherein capturing the response to the prompt comprises:
after automatically operating the GUI, detecting an update to a second UI element in the GUI, wherein the second UI element is configured to display the response; and
in response to detecting the update to the second UI element, obtaining a screenshot, an audio recording, or a video recording of the second UI element.

6. The computer-implemented method of claim 4, wherein the generative model is implemented on the client device.

7. The computer-implemented method of claim 1, wherein the safety filter is implemented using a large language model (LLM) fine-tuned for test evaluation, and wherein determining the test result comprises:
providing, as input to the LLM, a question that comprises the prompt, the response, and the policy; and
receiving, as output of the LLM, the test result.

8. The computer-implemented method of claim 1, wherein determining, using the safety filter, the test result that indicates whether the response violates the policy associated with the test category comprises determining whether the response is different from a default response associated with the test category.

9. A computing device comprising:
a processor; and
a memory coupled to the processor, with instructions stored thereon that, when executed by the processor, cause the processor to perform operations comprising:
generating, using a prompt generator, a plurality of prompts, each prompt associated with a respective test category, wherein each prompt includes one or more of prompt text, prompt image, prompt audio, or prompt video;
for each of the plurality of prompts,
providing the prompt to a generative model;
capturing a response to the prompt, the response produced by the generative model, wherein the response comprises one or more of: response text, response image, response audio, or response video; and
storing the prompt and the response in a database; and
analyzing respective pairs of prompts and corresponding responses to determine generative model performance, wherein the analyzing comprises, for each pair, determining, using a safety filter, a test result that indicates whether the response violates a policy associated with the test category.

10. The computing device of claim 9, wherein generating the plurality of prompts comprises:
sending a command to the prompt generator, wherein the command includes one or more sample prompts for the test category; and
receiving, in response to the command, one or more prompts of the plurality of prompts.

11. The computing device of claim 9, wherein the generative model is accessible via a graphical user interface (GUI) of a software application, and wherein providing the prompt to the generative model comprises:
identifying a first user interface (UI) element in the GUI that is configured to receive input prompts; and
automatically operating the GUI to insert the prompt into the first UI element and to trigger the generative model to generate the response.

12. The computing device of claim 11, wherein capturing the response to the prompt comprises:
after automatically operating the GUI, detecting an update to a second UI element in the GUI, wherein the second UI element is configured to display the response; and
in response to detecting the update to the second UI element, obtaining a screenshot, an audio recording, or a video recording of the second UI element.

13. The computing device of claim 9, wherein the safety filter is implemented using a large language model (LLM) fine-tuned for test evaluation, and wherein determining the test result comprises:
providing, as input to the LLM, a question that comprises the prompt, the response, and the policy; and
receiving, as output of the LLM, the test result.

14. The computing device of claim 9, wherein determining, using the safety filter, the test result that indicates whether the response violates the policy associated with the test category comprises determining whether the response is different from a default response associated with the test category.

15. A non-transitory computer-readable medium with instructions stored thereon that, when executed by a processor, cause the processor to perform operations comprising:
generating, using a prompt generator, a plurality of prompts, each prompt associated with a respective test category, wherein each prompt includes one or more of prompt text, prompt image, prompt audio, or prompt video;
for each of the plurality of prompts,
providing the prompt to a generative model;
capturing a response to the prompt, the response produced by the generative model, wherein the response comprises one or more of: response text, response image, response audio, or response video; and
storing the prompt and the response in a database; and
analyzing respective pairs of prompts and corresponding responses to determine generative model performance, wherein the analyzing comprises, for each pair, determining, using a safety filter, a test result that indicates whether the response violates a policy associated with the test category.

16. The non-transitory computer-readable medium of claim 15, wherein generating the plurality of prompts comprises:
sending a command to the prompt generator, wherein the command includes one or more sample prompts for the test category; and
receiving, in response to the command, one or more prompts of the plurality of prompts.

17. The non-transitory computer-readable medium of claim 15, wherein the generative model is accessible via a graphical user interface (GUI) of a software application, and wherein providing the prompt to the generative model comprises:
identifying a first user interface (UI) element in the GUI that is configured to receive input prompts; and
automatically operating the GUI to insert the prompt into the first UI element and to trigger the generative model to generate the response.

18. The non-transitory computer-readable medium of claim 17, wherein capturing the response to the prompt comprises:
after automatically operating the GUI, detecting an update to a second UI element in the GUI, wherein the second UI element is configured to display the response; and
in response to detecting the update to the second UI element, obtaining a screenshot, an audio recording, or a video recording of the second UI element.

19. The non-transitory computer-readable medium of claim 15, wherein the safety filter is implemented using a large language model (LLM) fine-tuned for test evaluation, and wherein determining the test result comprises:
providing, as input to the LLM, a question that comprises the prompt, the response, and the policy; and
receiving, as output of the LLM, the test result.

20. The non-transitory computer-readable medium of claim 15, wherein determining, using the safety filter, the test result that indicates whether the response violates the policy associated with the test category comprises determining whether the response is different from a default response associated with the test category.
